(19) United States
(12) Patent Application Publication
(10) Pub. No.: US 2012/0005485 A1
(43) Pub. Date: Jan. 5, 2012

(54) STORAGE DEVICE AND INFORMATION PROCESSING APPARATUS

(75) Inventor: Toru KAMBAYASHI, Kanagawa (JP)

(73) Assignee: Kabushiki Kaisha Toshiba, Tokyo (JP)

(21) Appl. No.: 13/035,151

(22) Filed: Feb. 25, 2011

(30) Foreign Application Priority Data
Jul. 1, 2010 (JP) 2010-151420

(51) Int. Cl. G06F 12/14

(52) U.S. Cl. 713/193

(57) ABSTRACT

According to one embodiment, a storage device includes a data storage unit, a receiving unit, a selecting unit, and an authenticating unit. The data storage unit includes a secret area that becomes readable when authentication has been made by using reading authentication information and that becomes writable when authentication has been made by using writing authentication information. The receiving unit receives an access request that is either a write request indicating that data should be written into the secret area or a read request indicating that data should be read from the secret area. The selecting unit selects the writing authentication information if the access request is the write request and selects the reading authentication information if the access request is the read request. The authenticating unit authenticates an access to the secret area by using one of the writing authentication information and the reading authentication information that has been selected.

### CROSS-REFERENCE TO RELATED APPLICATIONS

This application is based upon and claims the benefit of priority from Japanese Patent Application No. 2010-151420, filed on Jul. 1, 2010; the entire contents of which are incorporated herein by reference.

### FIELD

Embodiments described herein relate generally to a storage device that stores therein content data or the like for which copyright protection is sought and an information processing apparatus that includes such a storage device.

### BACKGROUND

There is a content distributing system for a content utilizing terminal that includes a storage device such as a Secure Digital (SD) card or an information Versatile Disk for Removable usage (iVDR), which stores therein data (i.e., content data) and has a copyright protection function, and an accessing device that accesses the storage device to utilize the content data. In order for the accessing device included in the content utilizing terminal to properly write data into a secret area of the storage device and to properly read data from the secret area, the accessing device needs to be authenticated by the storage device. In order for the accessing device to be authenticated by the storage device, the accessing device needs to have authentication information stored therein.

In conventional techniques, however, if the authentication information is illegitimately obtained from the accessing device, it becomes possible to rewrite the information stored in the secret area.

### BRIEF DESCRIPTION OF THE DRAWINGS

FIG. 1 is a diagram of an exemplary configuration of a content distributing system according to a first embodiment;

FIG. 2 is a diagram of an exemplary configuration of a content distributing system in which authentication information used for a writing process is the same as authentication information used for a reading process;

FIG. 3 is a diagram of another exemplary configuration of a content distributing system in which authentication information used for a writing process is the same as authentication information used for a reading process;

FIG. 4 is a block diagram of examples of detailed functional configurations of devices that are included in the content distributing system according to the first embodiment;

FIG. 5 is a drawing of an example of a format of a write command;

FIG. 6 is a drawing of an example of a format of a read command;

FIG. 7 is a drawing of an example of a data structure of authentication information stored in an authentication information storage unit;

FIG. 8 is a flowchart of an overall flow in an accessing process according to the first embodiment;

FIG. 9 is a block diagram of examples of detailed functional configurations of devices that are included in a content distributing system according to a second embodiment;

FIG. 10 is a drawing of an example of a data structure of authentication information stored in an authentication information storage unit;

FIG. 11 is a drawing of an example of a write command;

FIG. 12 is a drawing of an example of a read command;

FIG. 13 is a block diagram of an exemplary configuration of a content distributing system according to a third embodiment;

FIG. 14 is a drawing of an example of a format of an initialize command;

FIG. 15 is a drawing of an example of a format of an update command;

FIG. 16 is a drawing of an example of a data structure of update information;

FIG. 17 is a drawing of an example of authentication information stored in the authentication information storage unit;

FIG. 18 is a drawing of an example of authentication information stored in the authentication information storage unit;

FIG. 19 is a block diagram of an exemplary configuration of a content distributing system according to a fourth embodiment;

FIG. 20 is a drawing of an example of a format of an update command;

FIG. 21 is a drawing of an example of a data structure of update information;

FIG. 22 is a drawing of an example of authentication information stored in the authentication information storage unit; and

FIG. 23 is a drawing explaining a hardware configuration of devices according to any of the first through the fourth embodiments.

### DETAILED DESCRIPTION

In general, according to one embodiment, a storage device includes a data storage unit, a receiving unit, a selecting unit, and an authenticating unit. The data storage unit includes a secret area that becomes readable when authentication has been made by using reading authentication information and that becomes writable when authentication has been made by using writing authentication information. The receiving unit receives an access request that is either a write request indicating that data should be written into the secret area or a read request indicating that data should be read from the secret area. The selecting unit selects the writing authentication information if the access request is the write request and selects the reading authentication information if the access request is the read request. The authenticating unit authenticates an access to the secret area by using one of the writing authentication information and the reading authentication information that has been selected.

In the following sections, exemplary embodiments of a storage device and an information processing apparatus will be explained in detail, with reference to the accompanying drawings.

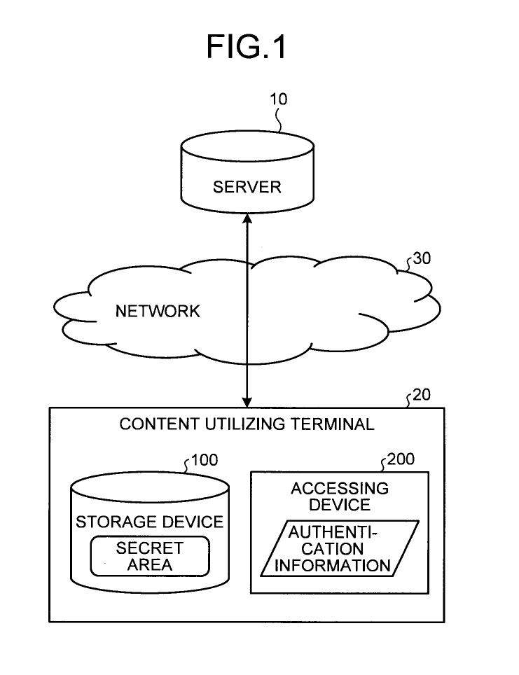

FIG. 1 is a diagram of an exemplary configuration of a content distributing system according to a first embodiment. As shown in FIG. 1, the content distributing system is configured such that a server 10 and a content utilizing terminal 20 serving as an information processing apparatus are connected to each other via a network 30 such as the Internet. The content utilizing terminal 20 includes a storage device 100 and an accessing device 200. The accessing device 200 has stored therein authentication information used for an authentication process performed with the storage device 100. The storage device 100 includes a secret area that becomes accessible in the case where authentication has been made by using the authentication information.

The storage device 100 may be configured by using not only an SD card or an iVDR, but also any commonly-used storage medium such as a Hard Disk Drive (HDD), an optical disk, a memory card, or a Random Access Memory (RAM).

In the content distributing system, for example, a binding ID of the content utilizing terminal 20 is stored in the secret area of the storage device 100. The binding ID is an ID used for encrypting a title key (i.e., a key used for decrypting an encrypted content that has been distributed). More specifically, for example, to store a title key KT into the storage device 100, the title key is stored in the form expressed as KTb=AE(AG(K0, 1 Db),KT). In this expression, AE denotes an encryption function, whereas AG denotes a one-way function. Further, K0 denotes a master key, whereas IDb denotes a binding ID.

Even if KTb is copied into a storage device (called a storage device 100′) included in another content utilizing terminal (called a content utilizing terminal 20′) having a binding ID (e.g., IDb′) that is different from IDb, it is not possible to obtain KT by decrypting KTb. Although the content utilizing terminal 20′ can read IDb′ from a secret area of the storage device 100′, it is not possible to obtain KT by calculating AD(AG(K0, 1 Db′),KTb). In other words, the title key KTb is usable only by the content utilizing terminal 20, which has the binding ID “IDb”. This situation can be expressed as “the title key KTb is bound to IDb”.

In a content distributing system, a binding ID may be used in common for a plurality of content utilizing terminals 20. In that situation, for example, a terminal ID that identifies a content utilizing terminal 20 and the binding ID are stored in the secret area of the storage device 100 included in the content utilizing terminal 20. For example, a content utilizing terminal 20 of which the terminal ID is TIDx has a set expressed as (UIDa,TIDx,IDb) stored in the secret area of the storage device 100. In this situation, UIDa denotes a user ID of the user who owns the content utilizing terminal 20. A part of these pieces of data (e.g., the terminal ID) is written into the content utilizing terminal 20 when the content utilizing terminal 20 is shipped from the factory. The user ID and the binding ID are written by the server included in the content distributing system.

Another content utilizing terminal 20 (of which the terminal ID is TIDy) owned by the same user has (UIDa, TIDy, IDb) stored in the secret area of the storage device 100 that is included therein. With these arrangements, it is possible to share a content between the content utilizing terminal 20 of which the terminal ID is “TIDx” and the content utilizing terminal 20 of which the terminal ID is “TIDy”. In other words, the title key bound to IDb is usable by these two content utilizing terminals 20.

As explained above, the content utilizing terminal 20 storing the authentication information therein is able to read data from the secret area of the storage device 100. An adversary who intends to illegitimately use the content may be able to illegitimately read the authentication information by analyzing the accessing device 200. Because the content utilizing terminals 20 are provided at the users' locations, the content utilizing terminals 20 are prone to be attacked.

In the case where an adversary has obtained the authentication information, the adversary is able to rewrite the binding ID or the user ID. For example, a situation can be considered in which, in the example described above, the adversary has illegitimately read the set made up of the user ID, the terminal ID, and the binding ID expressed as (UIDa, TIDx, IDb) from the secret area of the storage device 100 included in the content utilizing terminal 20 and has written the set into the secret area of the storage device 100′ included in the other content utilizing terminal 20′. In that situation, the content utilizing terminal 20′ becomes able to utilize the content that is bound to the content utilizing terminal 20. Further, for the server, the content utilizing terminal 20′ is not distinguishable from the content utilizing terminal 20.

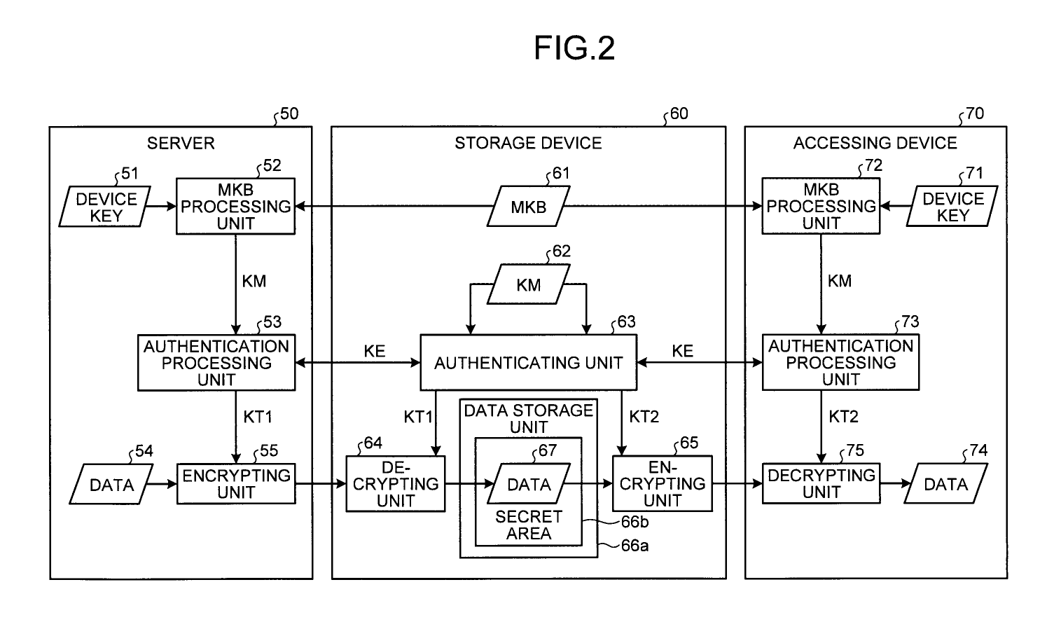

Next, an exemplary configuration in which authentication information used for a writing process is the same as authentication information used for a reading process will be explained. FIG. 2 is a diagram of an exemplary configuration of a content distributing system in which authentication information used for a writing process is the same as authentication information used for a reading process.

The content distributing system in the present example includes a server 50, a storage device 60, and an accessing device 70. The storage device 60 and the accessing device 70 may be configured, for example, so as to be included in the same content utilizing terminal, like in the example described above.

The server 50 includes a device key 51 assigned to the server 50, a Media Key Block (MKB) processing unit 52, an authentication processing unit 53, data 54, and an encrypting unit 55. The MKB processing unit 52 performs an MKB process, which is to derive a media key KM by processing a Media Key Block (MKB) while using the device key 51. In the present exemplary configuration, the media key KM obtained as a result of performing the MKB process is the authentication information.

The authentication processing unit 53 performs an authentication process with the storage device 60, by using the authentication information. For example, the authentication processing unit 53 realizes a mutual authentication process between the server 50 and the storage device 60 by performing a key exchange procedure (hereinafter, the “key exchange process KE”) that uses the media key KM.

The data 54 is data such as content data that is to be written into a secret area 66b. The encrypting unit 55 encrypts the data 54 by using a common key that has been generated as a result of the key exchange process KE.

The accessing device 70 includes a device key 71 assigned to the accessing device 70, an MKB processing unit 72, an authentication processing unit 73, data 74, and a decrypting unit 75. The MKB processing unit 72 and the authentication processing unit 73 have the same functions as the MKB processing unit 52 and the authentication processing unit 53, respectively, that are included in the server 50. The decrypting unit 75 decrypts the data that has been encrypted by using the common key that has been generated as a result of the key exchange process KE.

The storage device 60 includes an MKB 61 used in the MKB process, a media key KM 62, an authenticating unit 63, a decrypting unit 64, an encrypting unit 65, and a data storage unit 66a that has data 67 stored in the secret area 66b.

The authenticating unit 63 authenticates access to the secret area 66b by using the authentication information. For example, the authenticating unit 63 performs the authentication process by performing, for example, the key exchange process KE that uses the media key KM, between the authentication processing unit 53 included in the server 50 and the authentication processing unit 73 included in the accessing device 70.

During the key exchange process KE performed between the storage device 60 and the server 50, a common key KT1 is generated by using the media key KM, which is the authentication information shared between the storage device 60 and the server 50, and using a random number that is exchanged between the storage device 60 and the server 50. Also, during the key exchange process KE performed between the storage device 60 and the accessing device 70, a common key KT2 is generated by using the media key KM, which is the authentication information shared between the storage device 60 and the accessing device 70, and using a random number that is exchanged between the storage device 60 and the accessing device 70.

The common key KT1 is used for encrypting and decrypting processes that are performed when a writing process is performed. The common key KT2 is used for encrypting and decrypting processes that are performed when a reading process is performed. The common key KT1 and the common key KT2 are both information that is generated by using the media key KM. The media key KM (i.e., the authentication information) used for reading and writing data from and to the same secret area 66b is the same. A situation can be considered in which an adversary has analyzed the accessing device 70 and has illegitimately obtained the media key KM. In that situation, the adversary becomes able to write data into the secret area 66b by performing the same procedure as the key exchange process KE performed on the server 50 side.

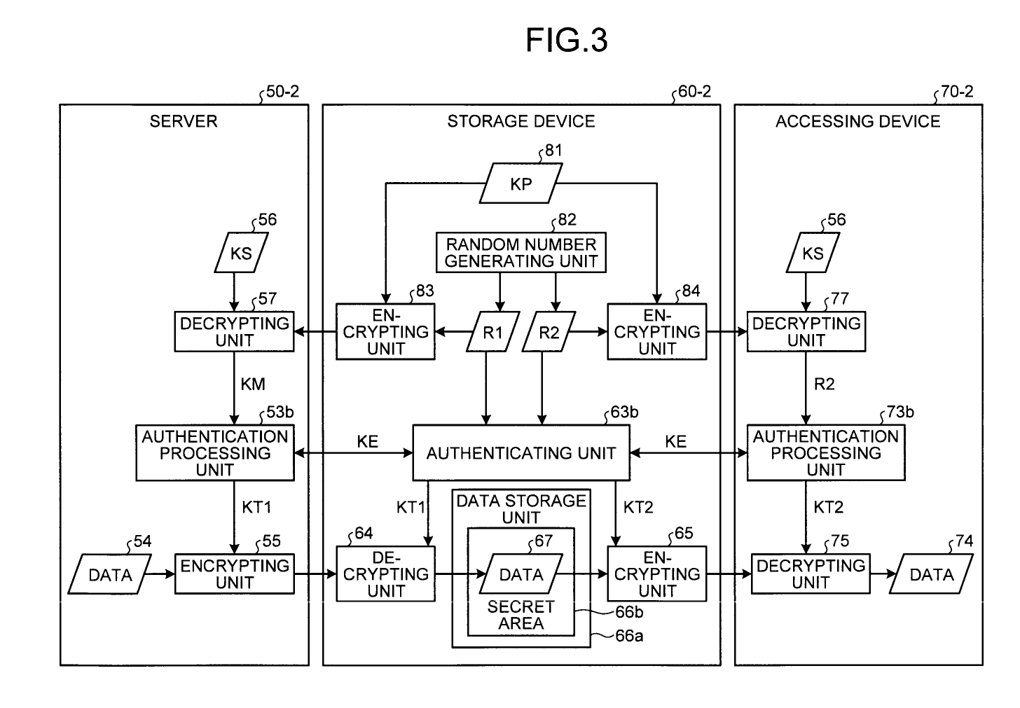

FIG. 3 is a diagram of another exemplary configuration of a content distributing system in which the authentication information used for a writing process is the same as the authentication information used for a reading process. In FIG. 3, an example in which a secret key and a public key corresponding to the secret key are used as the authentication information is shown.

The content distributing system shown in the example includes a server 50-2, a storage device 60-2, and an accessing device 70-2. Some of the components that have the same functions as those shown in FIG. 2 will be referred to by using the same reference characters, and the explanation thereof will be omitted.

The server 50-2 includes a secret key KS 56, a decrypting unit 57, an authentication processing unit 53b, the data 54, and the encrypting unit 55. The decrypting unit 57 decrypts a random number R1 that has been encrypted by the storage device 60-2, by using the KS 56. The authentication processing unit 53b performs an authentication process with the storage device 60-2 by using the random number R1, instead of the media key KM.

The accessing device 70-2 includes the KS 56, a decrypting unit 77, an authentication processing unit 73b, the data 74, and the decrypting unit 75. The decrypting unit 77 decrypts a random number R2 that has been encrypted by the storage device 60-2, by using the KS 56. The authentication processing unit 73b performs an authentication process with the storage device 60-2 by using the random number R2, instead of the media key KM.

The storage device 60-2 includes a public key KP 81 corresponding to the secret key (i.e., the KS 56), a random number generating unit 82, encrypting units 83 and 84, an authenticating unit 63b, the decrypting unit 64, the encrypting unit 65, and the data storage unit 66a. The random number generating unit 82 generates the random numbers R1 and R2 that are used in the authentication processes. The encrypting units 83 and 84 encrypt the random numbers R1 and R2, respectively. It should be noted that, although the encrypting units 83 and 84 are shown separately in the example in FIG. 3, it is acceptable to configure the encrypting units 83 and 84 as a single encrypting unit. The authenticating unit 63b may authenticate access to the secret area 66b by using either the random number R1 or the random number R2.

As explained above, the storage device 60-2 has the public key (i.e., the KP 81) stored therein. When a writing process is to be performed, the storage device 60-2 generates the random number R1, encrypts the random number R1 by using the KP 81, and sends the encrypted random number to the server 50-2. The server 50-2 decrypts the random number R1 that has been encrypted by using the secret key KS 56 so as to obtain the random number R1 and uses the random number R1 for the key exchange process KE. The storage device 60-2 also uses the same random number R1 for the key exchange process KE and thus obtains the same common key KT1. The procedure that is performed when a reading process is to be performed is the same as the one for the writing process. The authentication information KS used for reading and writing data from and to the same secret area 66b is the same. A situation can be considered in which an adversary has analyzed the accessing device 70-2 and has illegitimately obtained the KS 56. In that situation, the adversary becomes able to write data into the secret area 66b by performing the same procedure as the key exchange process KE performed on the server 50-2 side.

To cope with this situation, the storage device 100 according to the first embodiment has stored therein authentication information (i.e., writing authentication information) that permits writing data into the secret area 66b and authentication information (i.e., reading authentication information) that only permits reading data from the secret area 66b, separately from each other. When having received a write command indicating that data should be written into the secret area 66b, the storage device 100 performs an authentication process with the sender of the command by selecting the writing authentication information. In contrast, when having received a read command indicating that data should be read from the secret area 66b, the storage device 100 performs an authentication process with the sender of the command by selecting the reading authentication information. With these arrangements, only such devices (e.g., the server 10) that have the writing authentication information stored therein are able to write data into the secret area 66b of the storage device 100.

Generally speaking, because the accessing device 200 that utilizes the data stored in the storage device 100 is provided at the user's location, the accessing device 200 is prone to be attacked through illegitimate analyses of computer programs and the like. The accessing device 200, however, has only the reading authentication information stored therein. Thus, even in the case where the accessing device 200 is analyzed and the reading authentication information is illegitimately read, it is not possible to tamper the data stored in the secret area 66b.

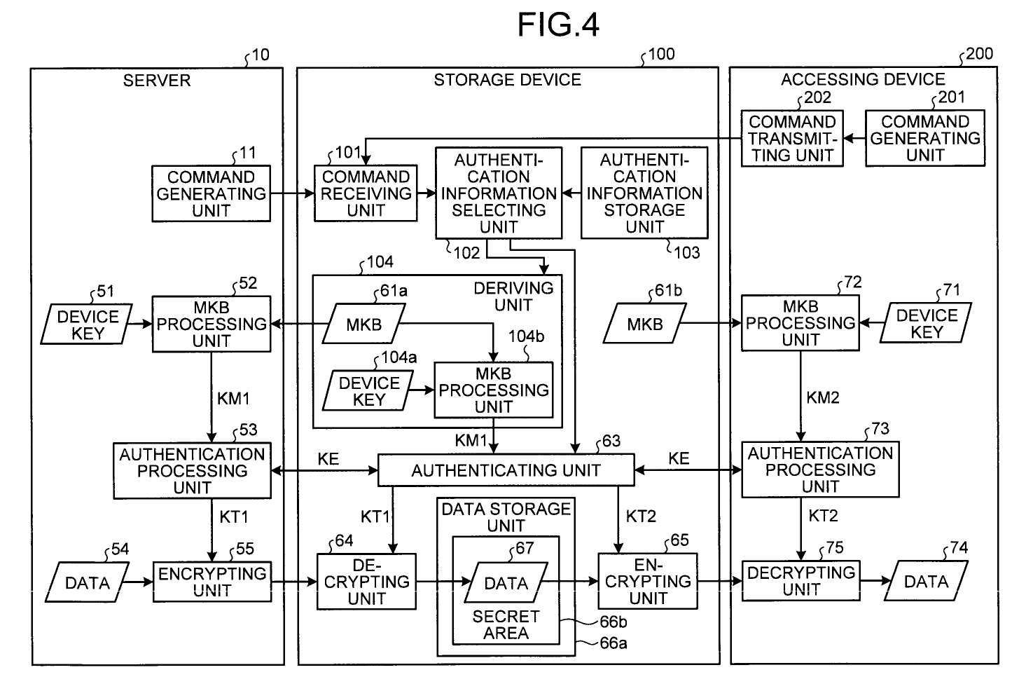

FIG. 4 is a block diagram of examples of detailed functional configurations of the devices (i.e., the server 10, the storage device 100, and the accessing device 200) that are included in the content distributing system according to the first embodiment. Some of the components that have the same functions as those shown in FIG. 2 will be referred to by using the same reference characters, and the explanation thereof will be omitted.

The server 10 includes a command generating unit 11, the device key 51, the MKB processing unit 52, the authentication processing unit 53, the data 54, and the encrypting unit 55. The command generating unit 11 generates a command that requests access to the secret area 66b. For example, the command generating unit 11 generates a write command that requests that data should be written into the secret area 66b.

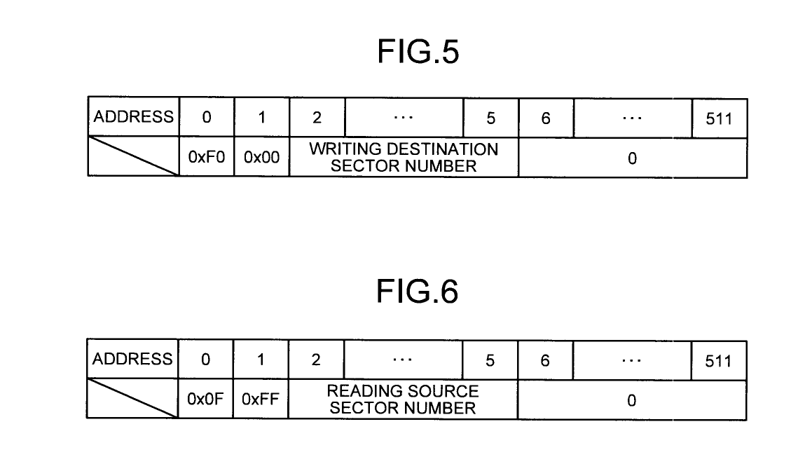

FIG. 5 is a drawing of an example of a format of the write command. In the example shown in FIG. 5, the size of the write command is 512 bytes. The first byte (at address “0”) represents a command number indicating that the command is a write command, and the command number is “0xF0” in the present example. The second byte of a write command is always “0x00”. The third through the sixth bytes represent a sector number of the writing destination (within the secret area 66b) into which the data is to be written. A sector is an example of units in which data is written. For example, one sector is equal to 512 bytes. The sector number is a number that identifies a sector. The size of a sector does not necessarily have to be 512 bytes. It is also possible to use any arbitrary units other than sectors as the units in which the data is written.

The seventh byte and the bytes thereafter in a write command must be “0”. Following the write command, a piece of 512-byte writing target data is sent. The storage device 100 records the writing target data into the sector within the secret area 66b that has been designated by the writing destination sector number.

Returning to the description of FIG. 4, the accessing device 200 includes a command generating unit 201, a command transmitting unit 202, the MKB processing unit 72, the authentication processing unit 73, the data 74, and the decrypting unit 75. The command generating unit 201 generates a read command requesting that data should be read from the secret area 66b. The command transmitting unit 202 transmits the generated read command to the storage device 100.

FIG. 6 is a drawing of an example of a format of the read command. In the example shown in FIG. 6, the size of the read command is 512 bytes. The first byte represents a command number indicating that the command is a read command, and the command number is “0x0F” in the present example. The second byte represents information that identifies the device being the sender of the command. For example, in a read command issued by the accessing device 200, the second byte is “0xFF”, whereas in a read command issued by the server, the second byte is “0x0F”. The third through the sixth bytes represent a sector number of the reading source location (within the secret area 66b) from which the data is to be read. The seventh byte and the bytes thereafter in a read command must be “0”. Following the read command, a piece of 512-byte reading target data is read from the storage device 100. The storage device 100 reads the reading target data from the sector within the secret area that has been designated by the reading source sector number.

Returning to the description of FIG. 4, the storage device 100 includes a command receiving unit 101, an authentication information selecting unit 102, an authentication information storage unit 103, a deriving unit 104, an MKB 61b, the authenticating unit 63, the decrypting unit 64, the encrypting unit 65, and the data storage unit 66a.

The command receiving unit 101 receives commands that are access requests transmitted from the server 10 and the accessing device 200. Examples of the commands include at least a write command and a read command.

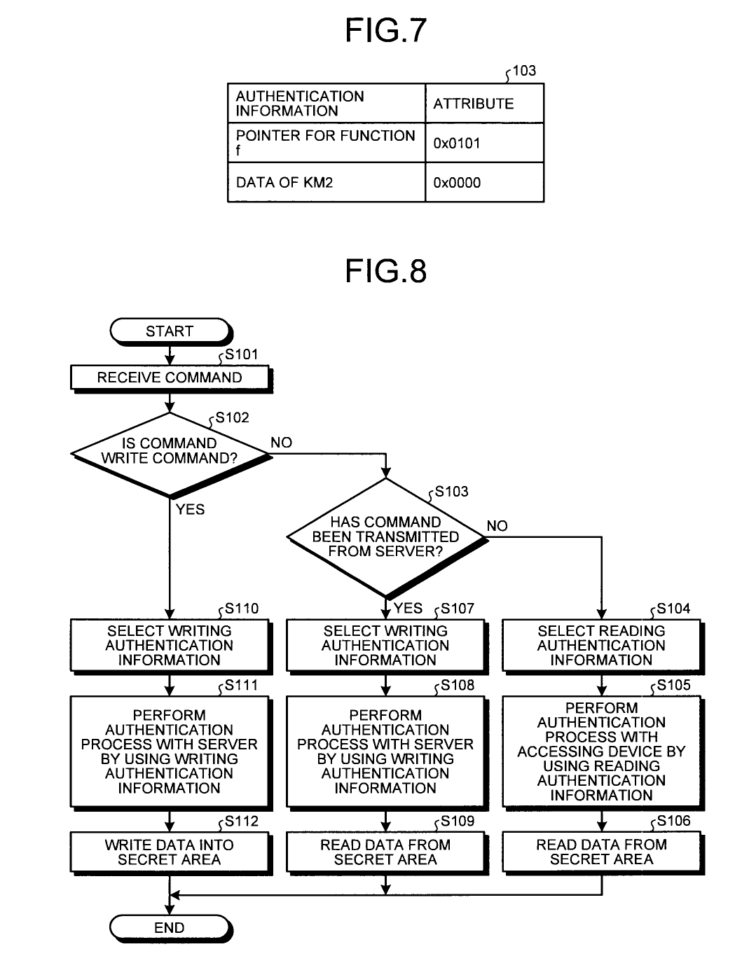

The authentication information storage unit 103 is a storage unit that stores therein the authentication information and is configured by using, for example, a nonvolatile memory. FIG. 7 is a drawing of an example of a data structure of the authentication information stored in the authentication information storage unit 103. The authentication information storage unit 103 stores therein the authentication information and an attribute of the authentication information in association with each other. The attribute is information (i.e., a flag) that indicates whether the authentication information is writing authentication information or reading authentication information. In the example shown in FIG. 7, the 2-byte numerical values “0x0101” and “0x0000” are the attributes indicating that the authentication information is writing authentication information and that the authentication information is reading authentication information, respectively.

The authentication information may store therein the data itself of the authentication information such as the media key. Alternatively, the authentication information may store therein a pointer for a function used for deriving the media key. In FIG. 7, an example is shown in which a pointer for a function f used for deriving the writing authentication information has been set into the first 16 bytes. In the first embodiment, the function f is a function used for calling the deriving unit 104. In the example shown in FIG. 7, the data of the media key KM2 serving as the reading authentication information is written starting from the 18th byte, whereas the following two bytes represent an attribute numerical value “0x0000” indicating that the authentication information is reading authentication information.

Alternatively, it is acceptable to configure the authentication information selecting unit 102 so as to store therein the authentication information. For example, it is acceptable to provide the authentication information storage unit 103 within the authentication information selecting unit 102.

Returning to the description of FIG. 4, in the case where the received command is a write command, the authentication information selecting unit 102 selects the writing authentication information as the authentication information to be used in the authentication process. In contrast, in the case where the received command is a read command, the authentication information selecting unit 102 selects the reading authentication information as the authentication information to be used in the authentication process. For example, by judging whether the first byte of the command is “0xF0” or “0x0F”, the authentication information selecting unit 102 recognizes whether the received command is a write command or a read command. The authentication information selecting unit 102 refers to the authentication information storage unit 103 and selects the authentication information having the attribute that corresponds to the type of command that has been recognized.

The deriving unit 104 includes an MKB 61a, a device key 104a, and an MKB processing unit 104b. The MKB processing unit 104b performs an MKB process on the MKB 61a by using the device key 104a and derives the media key KM1 serving as the writing authentication information. The deriving unit 104 forwards the derived media key KM1 to the authenticating unit 63 that performs the key exchange process KE.

The MKB 61a is an MKB used for permitting reading and writing processes. The MKB 61b is an MKB used for permitting a reading process. When the MKB 61a and the MKB 61b have been processed by using a device key, the media key KM1 and the media key KM2 that are different from each other are generated, respectively. In the first embodiment, the media key KM1 is the writing authentication information, whereas the media key KM2 is the reading authentication information. In the first embodiment, the storage device 100 does not have the media key KM1 stored therein and is configured so as to derive the media key KM1 by using the device key.

Alternatively, another arrangement is acceptable in which, instead of providing the deriving unit 104 that derives the media key KM1, the media key KM1 is stored in the authentication information storage unit 103. It is also acceptable to derive the media key KM2 by performing the same process as the one performed by the deriving unit 104.

Next, an accessing process to access the secret area 66b that is performed by the storage device 100 according to the first embodiment configured as described above will be explained, with reference to FIG. 8. FIG. 8 is a flowchart of an overall flow in the accessing process according to the first embodiment.

First, the command receiving unit 101 receives a command that has been transmitted from the server 10 or from the accessing device 200 (step S101). The authentication information selecting unit 102 judges whether the received command is a write command (step S102). In the case where commands having the formats shown in FIGS. 5 and 6 are used, the authentication information selecting unit 102 determines that the received command is a write command if the first byte of the command is “0xF0”.

In the case where the received command is not a write command (step S102: No), the authentication information selecting unit 102 further judges whether the command has been transmitted from the server 10 (step S103). For example, the authentication information selecting unit 102 determines that the received command is a command (i.e., a read command) that has been transmitted from the server 10 if the second byte of the command is “0x0F”.

In the case where the authentication information selecting unit 102 has determined that the received command was not transmitted from the server 10 (step S103: No), in other words, in the case where the received command was transmitted from the accessing device 200, the authentication information selecting unit 102 selects the reading authentication information as the authentication information (step S104). Subsequently, the authenticating unit 63 performs an authentication process with the accessing device 200, which is the sender, by using the reading authentication information that has bee selected (step S105). When having been authenticated, the accessing device 200 reads data from the secret area 66b (step S106).

In the case where the authentication information selecting unit 102 has determined at step S103 that the received command was transmitted from the server 10 (step S103: Yes), the authentication information selecting unit 102 selects the writing authentication information as the authentication information (step S107). The reason is that the server 10 performs an authentication process by using the writing authentication information for a data reading process, too.

The authenticating unit 63 performs an authenticating process with the server 10, which is the sender, by using the writing authentication information that has been selected (step S108). When having been authenticated, the server 10 reads data from the secret area 66b (step S109).

In the case where the authentication information selecting unit 102 has determined at step S102 that the received command is a write command (step S102: Yes), the authentication information selecting unit 102 selects the writing authentication information as the authentication information (step S110). The authenticating unit 63 performs an authenticating process with the server 10, which is the sender, by using the writing authentication information that has been selected (step S111). When having been authenticated, the server 10 writes data into the secret area 66b (step S112).

Next, the operation to write data into the secret area 66b according to the first embodiment will be explained more specifically.

The command generating unit 11 included in the server 10 generates the write command that has the format as shown in FIG. 5 and sends the generated write command to the storage device 100. The command receiving unit 101 included in the storage device 100 receives the write command and sends the received write command to the authentication information selecting unit 102.

The authentication information selecting unit 102 reads the first byte of the command and recognizes that the received command is a write command. The authentication information selecting unit 102 refers to the authentication information storage unit 103 and searches for the writing authentication information. In the example shown in FIG. 7, because the pointer for the function f corresponds to the flag (i.e., the attribute) of the writing authentication information, the authentication information selecting unit 102 calls the function f. In other words, the authentication information selecting unit 102 instructs the deriving unit 104 to derive the writing authentication information. The deriving unit 104 processes the MKB 61a by using the device key 104a and obtains the media key KM1 serving as the writing authentication information. The deriving unit 104 forwards the media key KM1 to the authenticating unit 63 so that the key exchange process KE can be performed.

The server 10 reads the MKB 61a from the storage device 100 and inputs the read MKB 61a to the MKB processing unit 52 included in the server 10. The MKB processing unit 52 included in the server 10 reads the device key 51 and processes the MKB 61a by using the device key 51. In the case where the device key 51 has been revoked by the MKB 61a, the MKB processing unit 52 included in the server 10 outputs an error, and the server 10 ends the writing operation. In contrast, in the case where the device key 51 has not been revoked by the MKB 61a, the MKB processing unit 52 included in the server 10 outputs the media key KM1. The MKB processing unit 52 included in the server 10 forwards the output media key KM1 to the authentication processing unit 53, which is to perform the key exchange process KE. During the key exchange process KE, the server 10 and the storage device 100 exchange a random number with each other by using a predetermined method so that both the server 10 and the storage device 100 each generate the common key KT1. The key exchange process KE is described as, for example, an Authentication and Key Exchange (AKE) process in the following Non-patent Document 1: 4C Entity, LLC. “CPRM Specification, SD Memory Card Book, Common Part”, Revision 0.961, May 3, 2007.

The server 10 inputs the piece of 512-byte writing target data to the encrypting unit 55. The encrypting unit 55 receives the common key KT1 from the authentication processing unit 53, encrypts the writing target data, and sends the encrypted writing target data to the storage device 100.

When having received the writing target data that has been encrypted (hereinafter, the “encrypted writing target data”), the storage device 100 inputs the encrypted writing target data to the decrypting unit 64. The decrypting unit 64 receives the common key KT1 from the authenticating unit 63 and performs a decrypting process on the encrypted writing target data that has been received. The decrypting unit 64 outputs the writing target data resulting from the decrypting process. The storage device 100 records the writing target data into the secret area.

Next, the operation to read data from the secret area 66b according to the first embodiment will be explained more specifically. In the following sections, an example in which the accessing device 200 reads the data from the secret area 66b of the storage device 100 will be discussed.

The command receiving unit 101 included in the storage device 100 receives a read command that has been transmitted by the command transmitting unit 202 included in the accessing device 200 and sends the received read command to the authentication information selecting unit 102. The authentication information selecting unit 102 reads the first byte of the command and recognizes that the received command is a read command. Subsequently, the authentication information selecting unit 102 reads the second byte of the received command and recognizes that the command is a read command that has been issued by the accessing device 200. In this situation, the authentication information selecting unit 102 refers to the authentication information storage unit 103 and searches for the reading authentication information. In the example shown in FIG. 7, because the data of the media key KM2 corresponds to the flag (i.e., the attribute) of the reading authentication information, the authentication information selecting unit 102 forwards the media key KM2 to the authenticating unit 63. In the case where the second byte of the received read command is “0x0F”, the read command is a command that has been issued by the server 10. In that situation, the authentication information selecting unit 102 refers to the authentication information storage unit 103 and searches for the writing authentication information.

The accessing device 200 reads the MKB 61b from the storage device 100 and inputs the read MKB 61b to the MKB processing unit 72. The MKB processing unit 72 reads the device key 71 and processes the MKB 61b by using the device key 71. In the case where the device key 71 has been revoked by the MKB 61b, the MKB processing unit 72 outputs an error, and the accessing device 200 ends the reading operation. In contrast, in the case where the device key 71 has not been revoked by the MKB 61b, the MKB processing unit 72 outputs the media key KM2. The MKB processing unit 72 forwards the output media key KM2 to the authentication processing unit 73. During the key exchange process KE, the accessing device 200 and the storage device 100 exchange a random number with each other by using a predetermined method so that both the accessing device 200 and the storage device 100 each generate the common key KT2.

The storage device 100 reads the piece of 512-byte reading target data from the sector within the secret area 66b that has been designated by the read command and inputs the read data to the encrypting unit 65. The encrypting unit 65 receives the common key KT2 from the authenticating unit 63, encrypts the read data, and sends the encrypted read data to the accessing device 200. The accessing device 200 inputs the read data that has been encrypted (hereinafter, the “encrypted read data”) to the decrypting unit 75. The decrypting unit 75 receives the common key KT2 from the authentication processing unit 73 and performs a decrypting process on the encrypted read data that has been received, by using the common key KT2. The decrypting unit 75 outputs the read data resulting from the decrypting process.

As described above, according to the first embodiment, only the server 10 that has the writing authentication information stored therein is able to write data into the secret area 66b of the storage device 100. The accessing device 200, which is prone to be attacked, only has the reading authentication information stored therein. Thus, even in the case where the accessing device 200 is analyzed and the reading authentication information is illegitimately read, it is not possible to tamper the data stored in the secret area 66b.

Consequently, it is possible to prevent the data stored in the secret area from being illegitimately rewritten and thus possible to protect important data such as the user ID, the terminal ID, the binding ID, and the title key from being illegitimately tampered or copied. Because the reliability of the authentication between the server 10 and the storage device 100 is high, the reliability of the data that is stored in the secret area 66b and is read by the server 10 is high. Thus, it is also possible to utilize this function in a process to identify the content utilizing terminal 20. Further, because the reliability of the authentication between the server 10 and the storage device 100 is high, the certainty level of the server 10's erasing and changing the data stored in the secret area 66b is high. Thus, it is also possible to utilize this function in a process to, for example, initialize the storage device 100.

According to the first embodiment, the single secret area is provided, and one of the two types of authentication information (i.e., the writing authentication information and the reading authentication information) is selected to access the secret area. As a second embodiment, an example will be explained in which two types of authentication information are assigned to each of a plurality of secret sectors included in a secret area. Also, according to the second embodiment, a pair made up of a public key and a secret key is used as the authentication information.

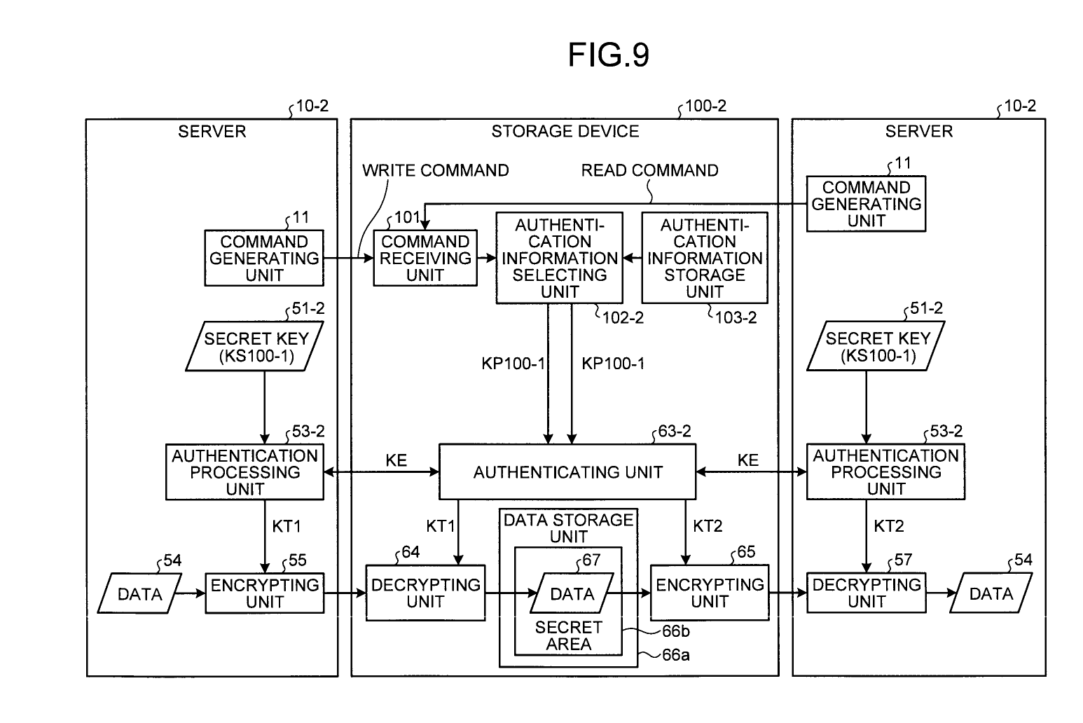

FIG. 9 is a block diagram of examples of detailed functional configurations of devices (i.e., a server 10-2 and a storage device 100-2) that are included in a content distributing system according to the second embodiment. Some of the components that have the same functions as those shown in FIG. 4, which is a block diagram for the first embodiment, will be referred to by using the same reference characters, and the explanation thereof will be omitted.

In the following sections, an example in which a read command is transmitted by the server 10-2 will be explained. For this reason, in FIG. 9, the components of the server 10-2 that are involved in the transmission of a write command are shown on the left-hand side of the storage device 100-2, whereas, separately from those, the components of the server 10-2 that are involved in the transmission of a read command are shown on the right-hand side of the storage device 100-2. In actuality, the components on both sides are included in the single server (i.e., the server 10-2). The processes that are performed when a read command is transmitted by the accessing device are the same as the processes that are performed when a read command is transmitted by the server 10-2 (because it is just that the sender is different).

The server 10-2 includes the command generating unit 11, a secret key 51-2, an authentication processing unit 53-2, the data 54, the encrypting unit 55, and a decrypting unit 56. The secret key 51-2 is a secret key that has been assigned to the server 10-2. In the following sections, for the sake of convenience in the explanation, it is assumed that the server 10-2 has stored therein a secret key KS 100-1 corresponding to a secret sector 100, as the secret key 51-2. The expression “secret sector n” (where 0≦n≦“the number of secret sectors−1”) denotes the (n+1)′th secret sector.

The authentication processing unit 53-2 is different from the authentication processing unit 53 shown in FIG. 4 in that the authentication processing unit 53-2 uses the KS 100-1 as the authentication information, instead of the media key KM1. The decrypting unit 56 decrypts data that has been read from the storage device 100-2 and has been encrypted.

The storage device 100-2 includes the command receiving unit 101, an authentication information selecting unit 102-2, an authentication information storage unit 103-2, an authenticating unit 63-2, the decrypting unit 64, the encrypting unit 65, and the data storage unit 66a.

The authentication information storage unit 103-2 has stores therein a public key as the authentication information. A secret key that corresponds to the public key is stored either in the server 10 or in the accessing device 200. Further, the authentication information storage unit 103-2 stores therein the authentication information for each of the secret sectors.

Next, the secret sectors will be explained. The secret sectors are the sectors that are secured in a secret area. A number that identifies each of the sectors is assigned to each sector, starting from 0. For example, it is possible to configure the secret area such that 65536 secret sectors identified as a secret sector 0 to a secret sector 65535 are secured therein.

Like in the first embodiment, writing authentication information and reading authentication information are assigned to each of the secret sectors. In other words, it is possible to treat each of the secret sectors independently like the secret area described in the first embodiment. The formats of the write command and the read command with respect to each of the secret sectors are the same as those described in the first embodiment. It should be noted, however, that operations performed by the authentication information selecting unit 102-2 are different from the operations performed according to the first embodiment, because each of the secret sectors is configured so as to be an independent secret area, according to the second embodiment. The details of the functions of the authentication information selecting unit 102-2 will be described later.

The authenticating unit 63-2 is different from the authenticating unit 63 shown in FIG. 4 in that the KS 100-1 is used as the authentication information, instead of the media keys KM1 and KM2.

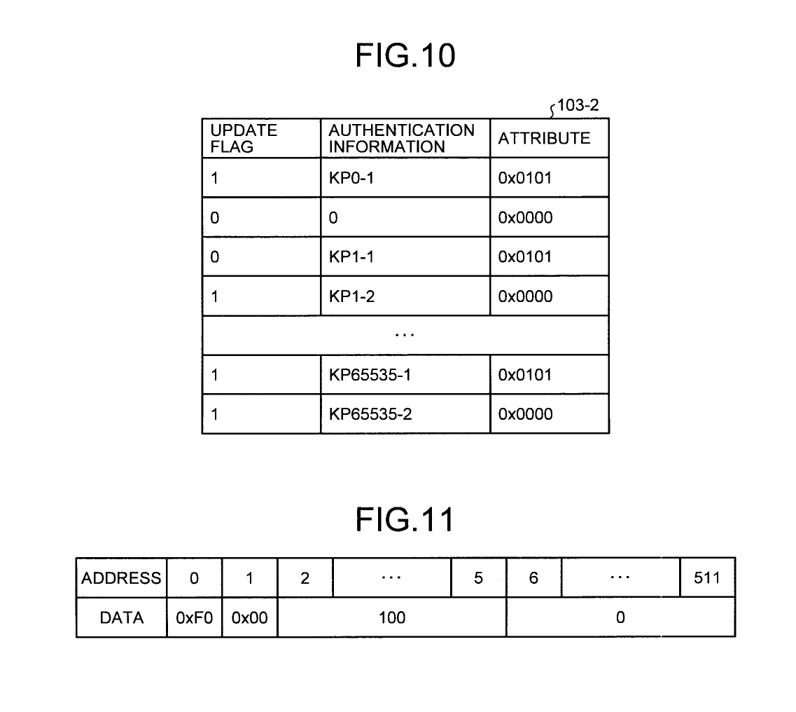

Next, details of the authentication information storage unit 103-2 will be further explained. The authentication information storage unit 103-2 has stored therein sets (e.g., 65536 sets) each of which is made up of writing authentication information and reading authentication information and each of which corresponds to a different one of the secret sectors. FIG. 10 is a drawing of an example of a data structure of the authentication information stored in the authentication information storage unit 103-2. The authentication information storage unit 103-2 stores therein an update flag, the authentication information, and an attribute of the authentication information in association with one another. The meanings of the attributes of the authentication information are the same as those shown in FIG. 7. In other words, the value “0x0101” indicates that the authentication information is writing authentication information, whereas the value “0x0000” indicates that the authentication information is reading authentication information. For example, a KP 1-1 is writing authentication information for a secret sector 1, whereas a KP 1-2 is reading authentication information for the secret sector 1. The update flag is a flag that indicates whether it is acceptable to update the authentication information for the secret sector. A utilization example of the update flag will be explained in detail in the description of a fourth embodiment. In the second embodiment, the update flag is not requisite. Another arrangement is acceptable in which the authentication information storage unit 103-2 stores therein only the authentication information and the attribute thereof, in association with each other.

Next, the operation to write data into the secret area 66b according to the second embodiment will be explained more specifically. In the following sections, an example will be explained in which the data is to be written into the secret sector 100, which is the 101st secret sector.

To write data into the secret sector 100, the command generating unit 11 included in the server 10-2 generates a write command as shown in FIG. 11 and sends the generated write command to the storage device 100-2. The command receiving unit 101 included in the storage device 100-2 receives the write command and sends the received write command to the authentication information selecting unit 102-2. The authentication information selecting unit 102-2 reads the first byte (i.e., 0xF0) of the write command and recognizes that the received command is a write command. Also, the authentication information selecting unit 102-2 reads the four bytes starting from the third byte and recognizes that the write command is a write request indicating that data should be written into the secret sector 100, which is the 101st secret sector. In that situation, the authentication information selecting unit 102-2 conducts a search in the data as shown in FIG. 10 that is stored in the authentication information storage unit 103-2 and finds the 101st set of authentication information. In other words, the authentication information selecting unit 102-2 finds a KP 100-1 and a KP 100-2 (not shown in FIG. 10). The authentication information selecting unit 102-2 checks the attributes of the KP 100-1 and the KP 100-2 and selects the KP 100-1, which is the writing authentication information. The authentication information selecting unit 102-2 sends the authentication information KP 100-1 that has been selected to the authenticating unit 63-2. A description of the operation performed by the authentication information selecting unit 102-2 in the case where a write command has been received has thus been completed. After a key exchange process with the server 10-2 has been performed, a piece of 512-byte data is written into the storage device 100-2 by the server 10-2. The storage device 100-2 performs a decrypting process so as to obtain the writing target data by using the common key KT1 that has been generated by the authenticating unit 63-2 and records the writing target data resulting from the decrypting process into the secret sector 100 within the secret area 66b.

Next, the operation to read data from the secret area 66b according to the second embodiment will be explained more specifically. In the following sections, an example will be explained in which the data is to be read from the secret sector 100, which is the 101st secret sector.

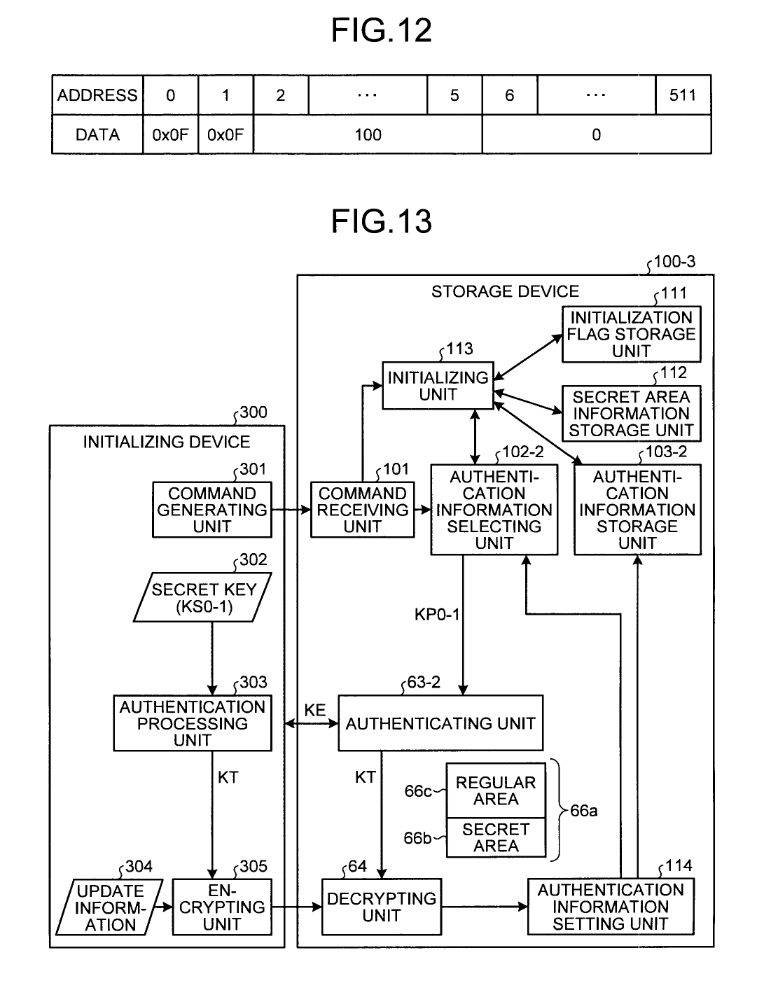

To read data from the secret sector 100, the command generating unit 11 included in the server 10-2 generates a read command as shown in FIG. 12 and sends the generated read command to the storage device 100-2. The command receiving unit 101 included in the storage device 100-2 receives the read command and sends the received read command to the authentication information selecting unit 102-2. The authentication information selecting unit 102-2 reads the first byte (i.e., 0x0F) of the read command and recognizes that the received command is a read command. Also, the authentication information selecting unit 102-2 reads the second byte (i.e., 0x0F) and recognizes that the read command is a command that has been issued by the server 10-2. In other words, the authentication information selecting unit 102-2 recognizes that the writing authentication information should be selected. The reason is that the authentication information used by the server 10-2 for reading and writing processes is the writing authentication information.

Subsequently, the authentication information selecting unit 102-2 reads the four bytes starting from the third byte and recognizes that the read command is a read request indicating that data should be read from the secret sector 100, which is the 101st secret sector. In that situation, the authentication information selecting unit 102-2 conducts a search in the data as shown in FIG. 10 that is stored in the authentication information storage unit 103-2 and finds the 101st set of authentication information. In other words, the authentication information selecting unit 102-2 finds the KP 100-1 and the KP 100-2. The authentication information selecting unit 102-2 checks the attributes of the KP 100-1 and the KP 100-2 and selects the KP 100-1, which is the writing authentication information. The authentication information selecting unit 102-2 sends the authentication information KP 100-1 that has been selected to the authenticating unit 63-2. A description of the operation performed by the authentication information selecting unit 102-2 in the case where a read command has been received has thus been completed. After a key exchange process with the server 10-2 has been performed, a piece of 512-byte data is read from the storage device 100-2 by the server 10-2. The storage device 100-2 reads the data recorded in the secret sector 100, encrypts the read data by using the common key KT2 that has been generated by the authenticating unit 63-2, and sends the encrypted data to the server 10-2.

As explained above, the storage device 100-2 according to the second embodiment has stored therein the writing authentication information and the reading authentication information for each of the sectors obtained by dividing the secret area into sections. Only the server 10-2 that has the writing authentication information stored therein is able to write data into a corresponding one of the sectors.

In the description of the second embodiment, the secret sectors were explained on the assumption that the authentication information (i.e., the writing authentication information and the reading authentication information) have been set into the authentication information storage unit 103-2 in advance. It is, however, not necessarily always the case that the authentication information has been set into the authentication information storage unit 103-2 for each of the secret sectors, at the point in time when the storage device 100-2 has been manufactured and is shipped from the factory.

As a third embodiment, a method for setting the authentication information for each of the secret sectors will be discussed. In the following sections, an example of setting the authentication information will be explained by using the secret sector 0, which is the first secret sector.

FIG. 13 is a block diagram of an exemplary configuration of a content distributing system according to the third embodiment. The content distributing system according to the third embodiment includes a storage device 100-3 and an initializing device 300 that initializes the authentication information stored in the storage device 100-3.

The initializing device 300 includes a command generating unit 301, a secret key 302, an authentication processing unit 303, an update information 304, and an encrypting unit 305.

The command generating unit 301 generates an initialize command requesting that the storage device 100-3 should be initialized and an update command requesting that the authentication information should be updated.

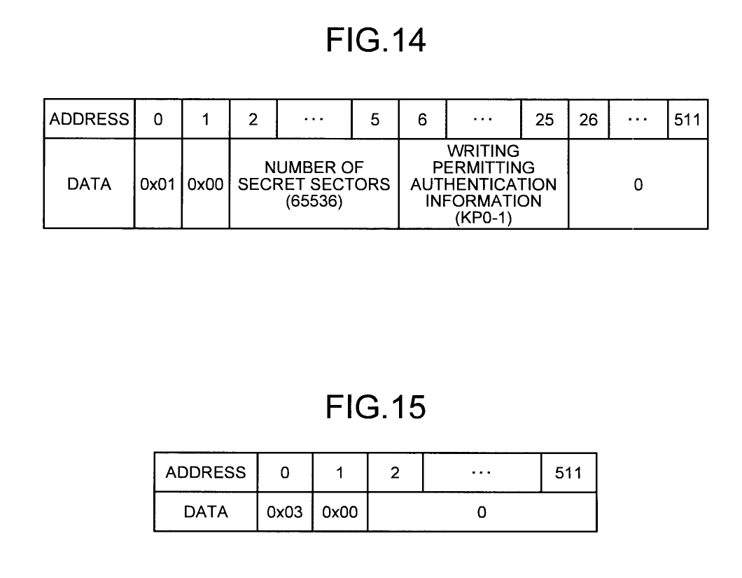

For example, the storage device 100-3 has not been initialized at the stage when the storage device 100-3 is shipped from the factory. To be “initialized” in this situation means that the secret area 66b is secured within the data storage unit 66a, and the authentication information is written so as to cause the secret area 66b to be usable. The storage device 100-3 is, for example, initialized at the manufacturer who manufactures the content utilizing terminal 20. An initialize command is used for this initialization process. FIG. 14 is a drawing of an example of a format of the initialize command.

The first byte of the initialize command represents a command number indicating that the command is an initialize command. The command number of the initialize command is “0x01”. The second byte of an initialize command is determined to be always “0x00”. In the four bytes starting from the third byte, the number of sectors that are to be secured as the secret area 66b is written. For example, one sector is equal to 512 bytes. An arrangement is acceptable in which the number of sectors to be secured as the secret area 66b is limited corresponding to the total number of sectors. For example, an arrangement is acceptable in which the quantity of the sectors (i.e., the secret sectors) to be secured as the secret area 66b is equal to or smaller than one eighth of the total number of sectors. In the present example, 64×1024=65536 sectors are to be secured in the secret area. The 20 bytes from the 7th byte through the 25th byte represent a public key KP 0-1, which is the writing authentication information to be set for the secret sector 0.

The secret sector 0 is a special secret sector. No reading authentication information is set for the secret sector 0, but “0” is always set, for example. It is possible to set only writing authentication information for the secret sector 0. In response to the initialize command (i.e., of which the command number is 0x01), the writing authentication information for the secret sector 0 is set (see FIG. 14). The initialize command with respect to the storage device 100-3 can be issued only once. If an initialize command is issued for the second time or more, either the initialize command will be ignored by the storage device 100-3 or an error will occur. In other words, it is possible to set the number of secret sectors only once, and it is possible to set the writing authentication information for the secret sector 0 only once.

Returning to the description of FIG. 13, the secret key 302 is a secret key that serves as writing authentication information corresponding to the writing authentication information (i.e., the public key KP 0-1) stored in the storage device 100-3. In the following sections, the secret key 302 may be referred to as a secret key KS 0-1. The authentication processing unit 303 performs an authentication process with the storage device 100-3 by using the secret key KS 0-1 as the authentication information. The update information 304 is information including the authentication information that should be stored into each of the secret sectors within the secret area 66b after the secret area 66b has been secured in response to the initialize command. The details of the update information 304 will be described later. The encrypting unit 305 encrypts the update information 304 by using a common key KT that has been output by the authentication processing unit 303 as a result of the authentication process.

The storage device 100-3 includes the command receiving unit 101, the authentication information selecting unit 102-2, the authentication information storage unit 103-2, an initialization flag storage unit 111, a secret area information storage unit 112, an initializing unit 113, an authentication information setting unit 114, and the data storage unit 66a. In the example shown in FIG. 13, only the components that are involved in the initialization process of the authentication information are shown; however, the storage device 100-3 may further include other components that are the same as those included in the storage device 100-2 according to the second embodiment (FIG. 9).

The command receiving unit 101, the authentication information selecting unit 102-2, the authentication information storage unit 103-2, and the data storage unit 66a have the same functions as those described in the second embodiment. Thus, these components will be referred to by using the same reference characters, and the explanation thereof will be omitted.

The initialization flag storage unit 111 is a storage unit that stores therein information (i.e., an initialization flag) indicating whether the initialization process has already been performed. For example, the initialization flag storage unit 111 may be configured by using a nonvolatile memory. For example, the initialization flag is set to 1 in the case where the initialization process has already been performed and is set to 0 in the case where the initialization process has not been performed. In this situation, the initialization flag storage unit 111 has “0” recorded therein at the time of the manufacture.

The secret area information storage unit 112 is a storage unit that stores therein information indicating the specifics of the settings for the secret area. For example, the secret area information storage unit 112 may be configured by using a nonvolatile memory. At the time of the manufacture, the total memory capacity of the storage device 100-3 (i.e., the total capacity of the storage area of the data storage unit 66a expressed in units of sectors) is recorded in the secret area information storage unit 112. Further, into the secret area information storage unit 112, it is possible to record information indicating a secret area starting sector, which is the sector at which the secret area starts. At the time of the manufacture, a numerical value that is the same as the value indicating the total memory capacity is stored as the secret area starting sector. It means that no secret area is present.

The initializing unit 113 refers to the initialization flag stored in the initialization flag storage unit 111. In the case where the initialization flag has the value (e.g., 0) indicating that the initialization process has not been performed, the initializing unit 113 performs an initializing operation. After the initialization process has been performed in response to the initialize command, the authentication information setting unit 114 performs a process to update the authentication information stored in the authentication information storage unit 103-2, by using the update information 304.

In the following sections, a flow in the initializing operation will be explained. The command generating unit 301 included in the initializing device 300 generates an initialize command as shown in FIG. 14 and transmits the generated initialize command to the storage device 100-3. The command receiving unit 101 included in the storage device 100-3 receives the initialize command that has been transmitted. The command receiving unit 101 reads the first byte and recognizes that the received command is an initialize command. The command receiving unit 101 sends the initialize command to the initializing unit 113. The initializing unit 113 first reads the value in the initialization flag storage unit 111 and, if the value is not 0, the initializing unit 113 stops the initializing operation. If the value in the initialization flag storage unit 111 is 0, the initializing unit 113 records 1 into the initialization flag storage unit 111 and continues the initializing operation thereafter. With this arrangement, the number of times the initialization process can be performed is limited to one.

The initializing unit 113 reads the four bytes starting from the third byte of the received initialize command and learns the number of sectors (i.e., the number of secret sectors) that should be secured as the secret area 66b. The initializing unit 113 reads the total memory capacity from the secret area information storage unit 112 and checks to see if the total memory capacity is eight or more times larger than the number of secret sectors. For example, in the case where the total memory capacity is 8 gigabytes (GB) (=16M sectors), the number of secret sectors shown in FIG. 14 (i.e., 64K=65536) is smaller than one eighth of the total memory capacity. If the total memory capacity is smaller than the value obtained by multiplying the number of secret sectors to be secured by 8, the storage device 100-3 stops the initialization process. If the total memory capacity is eight or more times larger than the number of secret sectors to be secured, the initializing unit 113 records a value obtained by calculating “the total memory capacity−the number of secret sectors”, as the secret area starting sector indicated in the secret area information storage unit 112. In the case where the total capacity is 16M sectors, whereas the number of secret sectors to be secured is 64K sectors, the initializing unit 113 records 16320×1024=16711680 as the secret area starting sector indicated in the secret area information storage unit 112. In other words, the 64K sectors from the sector number 16711680 to the sector number 16777215 serve as the secret area 66b. In the example shown in FIG. 13, of the data storage unit 66a, the area other than the secret area 66b is shown as a regular area 66c.

Subsequently, the initializing unit 113 reads 16 bytes of the initialize command starting from the seventh byte and recognizes the read value as the writing authentication information (i.e., the KP 0-1) for the secret sector 0. The initializing unit 113 records the value into the authentication information storage unit 103-2. The first row of the table in FIG. 10 shows the value that has been set in this manner. At the stage when the initialization process is performed in response to the initialize command, the pieces of authentication information in the third row and thereafter shown in FIG. 10 are all 0.

To use the secret sectors other than the secret sector 0, it is necessary to set authentication information that is not 0 for each of the secret sectors. This process is performed in response to an update command (of which the command number is 0x03). FIG. 15 is a drawing of an example of a format of the update command.

The first byte of the update command is the command number “0x03” indicating that the command is an update command. The second byte of an update command is determined to be always “0x00”. The value “0” is set into the third byte and the bytes thereafter.

In the following sections, operations performed by the storage device 100-3 and the initializing device 300 in response to the update command 0x03 will be explained. First, the command generating unit 301 included in the initializing device 300 generates an update command as shown in FIG. 15 and sends the generated update command to the storage device 100-3.

The command receiving unit 101 included in the storage device 100-3 receives the update command and sends the received update command to the authentication information selecting unit 102. The authentication information selecting unit 102 reads the first byte (i.e., 0x03) and recognizes that the received command is an update command. In this situation, the authentication information selecting unit 102 conducts a search in the data as shown in FIG. 10 that is stored in the authentication information storage unit 103-2 and finds the writing authentication information in the first set (i.e., the KP 0-1). The authentication information selecting unit 102 then sends the authentication information KP 0-1 to the authenticating unit 63-2. The initializing device 300 forwards the secret key KS 0-1 stored therein to the authentication processing unit 303. After the key exchange process KE has been performed between the initializing device 300 and the storage device 100-3, a piece of 512-byte data is written into the storage device 100-3 by the initializing device 300. The written data includes the update information 304.

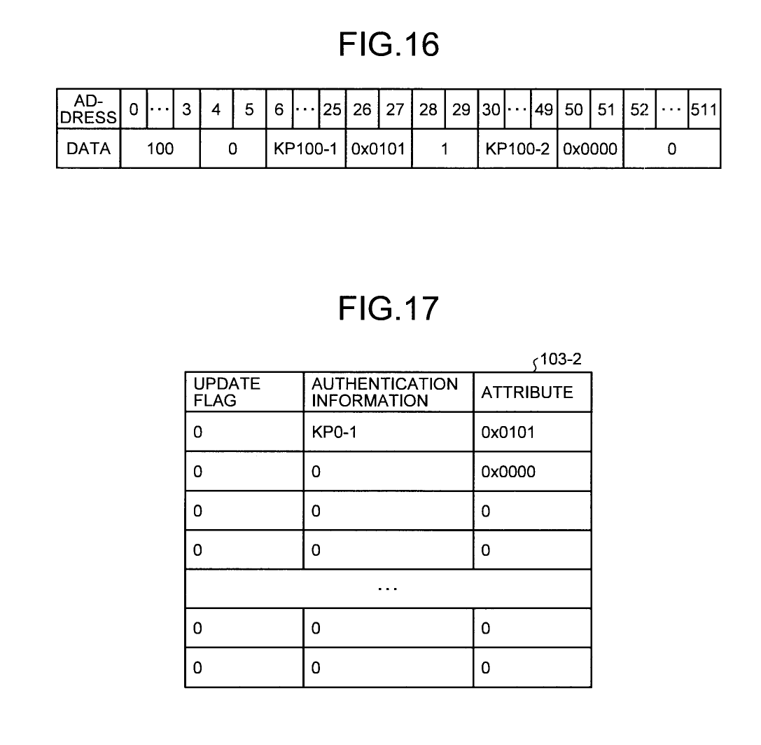

FIG. 16 is a drawing of an example of a data structure of the update information 304. The 1st through the 4th bytes represent a numerical value that identifies the secret sector to be updated. The 5th and the 6th bytes represent the value of the update flag. The 7th through the 26th bytes represent the authentication information with which the update is to be made. The 27th and the 28th bytes represent the attribute of the authentication information with which the update is to be made. The 29th through the 52nd bytes are the same as the 5th through the 28th bytes. In FIG. 16, an example of the update information to update the writing authentication information for the 101st secret sector with the KP 100-1 and to update the reading authentication information for the 101st secret sector with the KP 100-2 is shown.

The decrypting unit 64 included in the storage device 100-3 performs a decrypting process so as to obtain the update information by using the common key KT that has been generated as a result of the key exchange process KE and inputs the update information resulting from the decrypting process to the authentication information setting unit 114.

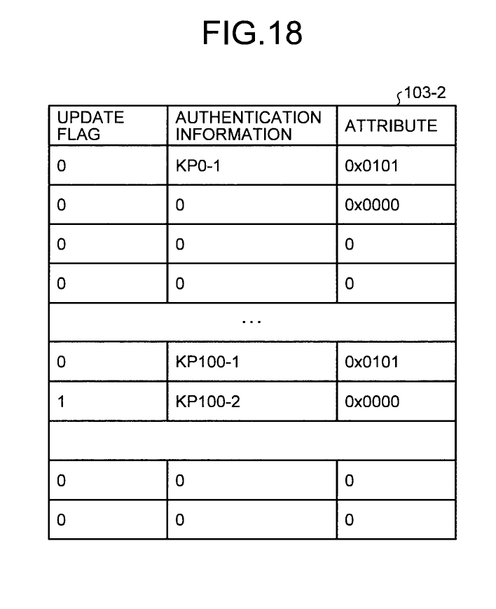

The authentication information setting unit 114 receives the update information as shown in FIG. 16 and updates the authentication information stored in the authentication information storage unit 103-2 with the received update information. The authentication information that is stored in the authentication information storage unit 103-2 immediately after the initialization has been performed is shown in FIG. 17. More specifically, in response to the initialize command, only the KP 0-1 is set as the writing authentication information. When having received the update information as shown in FIG. 16, the authentication information setting unit 114 sets the KP 100-1 and the KP 100-2 as the 101st writing authentication information and the 101st reading authentication information, respectively. Further, the authentication information setting unit 114 sets the value in the 5th and the 6th bytes and the value in the 29th and the 30th bytes that are shown in FIG. 16 as the update flags for the writing authentication information and for the reading authentication information, respectively. Further, the authentication information setting unit 114 sets the value in the 27th and the 28th bytes and the value in the 51st and the 52nd bytes that are shown in FIG. 16 as the attributes of the writing authentication information and of the reading authentication information, respectively. As a result, the authentication information stored in the authentication information storage unit 103-2 is in the state as shown in FIG. 18.

As explained above, according to the third embodiment, by using the initializing device 300 that is owned by, for example, the manufacturer who manufactures the content utilizing terminal 20, it is possible to achieve the function of initializing the authentication information stored in the secret area. In the description of the third embodiment, the example has been explained in which the secret area including the plurality of secret sectors like in the second embodiment is initialized. It is, however, also possible to achieve the same function with the secret area described in the first embodiment.

According to the third embodiment, the initializing device 300 initializes the secret area 66b and sets the authentication information. The initializing device 300 and the secret key KS 0-1 are, for example, owned by the manufacturer who manufactures the content utilizing terminal 20 so that it is possible to perform the initialization process and to set the authentication information by using the initializing device 300 and the secret key KS 0-1. There may be, however, a situation in which the manufacturer wishes to authorize a content distributing company to update the authentication information, the content distributing company owning a server that writes data into each of the secret areas (i.e., the secret sectors).

With regard to a storage device 100-4 according to a fourth embodiment, a method for realizing such a function will be explained.

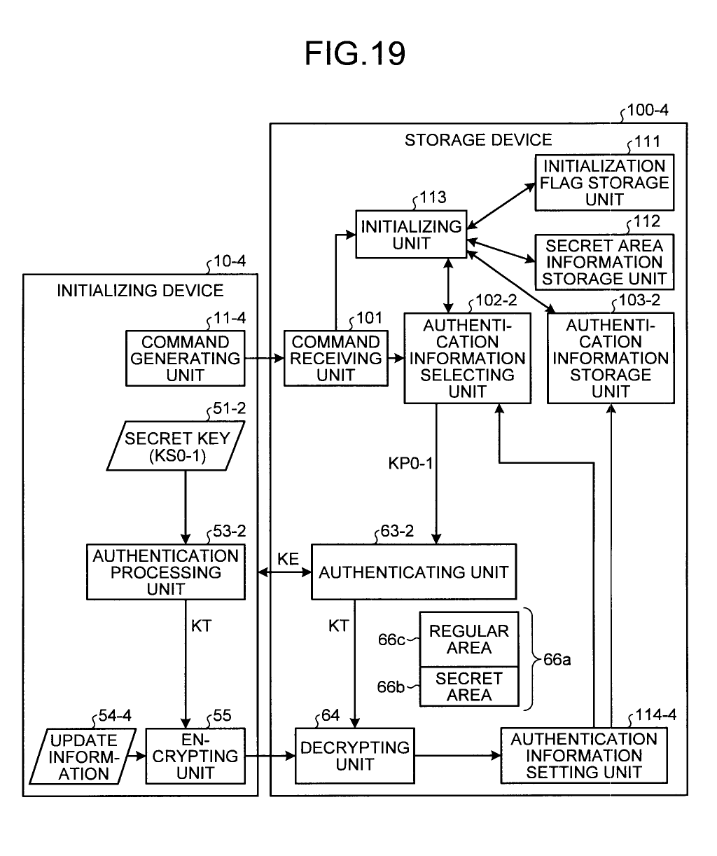

FIG. 19 is a block diagram of an exemplary configuration of a content distributing system according to the fourth embodiment. The content distributing system according to the fourth embodiment includes a server 10-4 and the storage device 100-4.

The server 10-4 includes a command generating unit 11-4, the secret key 51-2, the authentication processing unit 53-2, update information 54-4, and the encrypting unit 55. The secret key 51-2 is a secret key that has been assigned to the server 10-4. In the following sections, for the sake of convenience in the explanation, it is assumed that the server 10-4 has stored therein the secret key KS 100-1 corresponding to the secret sector 100, as the secret key 51-2.

The authentication processing unit 53-2 and the encrypting unit 55 have the same functions as those described in the second embodiment. Thus, these components will be referred to by using the same reference characters, and the explanation thereof will be omitted.

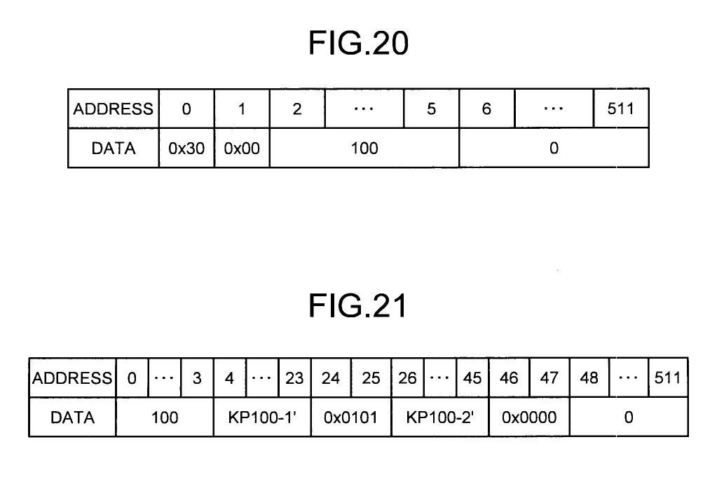

The command generating unit 11-4 is different from the command generating unit 11 described in the first through the third embodiments in that the command generating unit 11-4 further has a function of generating an update command used by the server 10-4 to request that the authentication information should be updated. FIG. 20 is a drawing of an example of a format of the update command.

The update command explained with reference to FIG. 15 is a command used for setting (or updating) the authentication information for the purpose of causing the secret sectors to be usable after the secret area has been secured. In contrast, the update command shown in FIG. 20 is a command used for updating the authentication information that has already been set, with a different value or the like. In the following sections, the command number of the update command shown in FIG. 20 is assumed to be “0x30” so that it is possible to distinguish the update command from the update command (of which the command number is “0x03”) shown in FIG. 15.

As shown in FIG. 20, the first byte of the update command represents the command number “0x30” indicating that the command is an update command. The second byte of an update command is determined to be always “0x00”. In the third through the sixth bytes, a numerical value that identifies the secret sector to be updated is set. The value “0” is set into the seventh byte and the bytes thereafter.

Returning to the description of FIG. 19, the update information 54-4 is information including the authentication information that should be stored into the secret sector to be updated. FIG. 21 is a drawing of an example of a data structure of the update information 54-4. The 1st through the 4th bytes represent a numerical value that identifies the secret sector to be updated. The 5th through the 24th bytes represent the authentication information with which the update is to be made. The 25th and the 26th bytes represent the attribute of the authentication information with which the update is to be made. The 27th through the 48th bytes are the same as the 5th through the 26th bytes. In FIG. 21, an example of the update information to update the writing authentication information for the 101st secret sector with the KP 100-1′ and to update the reading authentication information for the 101st secret sector with the KP 100-2′ is shown.

Returning to the description of FIG. 19, the storage device 100-4 is different from the storage device 100-3 according to the third embodiment (FIG. 13) in that the authentication information setting unit 114-4 further has a function of updating the authentication information stored in the authentication information storage unit 103-2 by using the update information 54-4.

The content distributing company receives the authentication information related to an assigned secret area (i.e., a secret sector) from, for example, the manufacturer who has performed the initialization process. Only after that, the content distributing company becomes able to read and write data from and to the secret area. In the example described above that is shown in FIG. 18, for instance, the content distributing company receives, from the manufacturer, the writing authentication information KS 100-1 (i.e., the secret key) for the writing authentication information KP 100-1 (i.e., the public key) and the reading authentication information KS 100-2 (i.e., the secret key) for the reading authentication information KP 100-2 (i.e., the public key). The content distributing company is able to construct the server 10-4 and the accessing device 200 that correspond to the secret sector 100.

In the case where the update flag is 1, the content distributing company is able to update the corresponding authentication information.

In the following sections, operations performed by the storage device 100-4 and the server 10-4 in response to the update command 0x30 will be explained. The command generating unit 11-4 included in the server 10-4 generates an update command as shown in FIG. 20 and sends the generated update command to the storage device 100-4. The command receiving unit 101 included in the storage device 100-4 receives the update command and sends the received update command to the authentication information selecting unit: 102-2. The authentication information selecting unit 102-2 reads the first byte (i.e., 0x30) and recognizes that the received command is an update command. In this situation, the authentication information selecting unit 102-2 reads the four bytes starting from the third byte of the update command and recognizes that the update command is for the secret sector 100. The authentication information selecting unit 102-2 conducts a search in the authentication information as shown in FIG. 18 that is stored in the authentication information storage unit 103-2 and finds the writing authentication information in the 101st set (i.e., the KP 100-1). The authentication information selecting unit 102-2 then sends the authentication information KP 100-1 to the authenticating unit 63-2. On the server 10-4 side, the secret key 51-2 (i.e., the KS 100-1) stored therein is sent to the authentication processing unit 53-2. After the key exchange process KE has been performed with the server 10-4, a piece of 512-byte data is written into the storage device 100-4 by the server 10-4. The written data includes the update information 54-4. The authenticating unit 63-2 included in the storage device 100-4 performs a decrypting process so as to obtain the update information 54-4 by using the common key KT that has been generated as a result of the key exchange process KE and inputs the update information 54-4 resulting from the decrypting process to the authentication information setting unit 114-4.

The authentication information setting unit 114-4 receives the update information 54-4 resulting from the decrypting process and updates the authentication information stored in the authentication information storage unit 103-2 with the received update information 54-4. It is assumed that the authentication information stored in the authentication information storage unit 103-2 is as shown in FIG. 18. When having received the update information 54-4 as shown in FIG. 21, the authentication information setting unit 114-4 checks the update flag for the 101st writing authentication information. Only if the value of the update flag is 1, it is possible to update the authentication information in response to the update command of which the command number is 0x30. In the example shown in FIG. 18, because the value of the update flag with respect to the 101st writing authentication information is 0, the authentication information setting unit 114-4 does not update the writing authentication information.

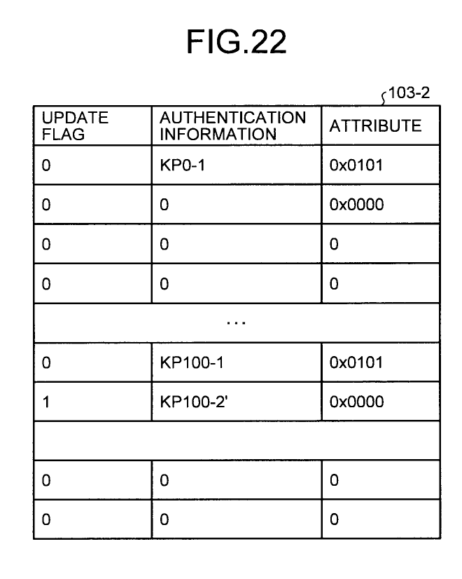

Subsequently, the authentication information setting unit 114-4 checks the update flag for the 101st reading authentication information. Because the value of the update flag is 1, the authentication information setting unit 114-4 replaces the reading authentication information with the reading authentication information (i.e., the KP 100-2′) included in the update information 54-4 shown in FIG. 21. As a result, the authentication information stored in the authentication information storage unit 103-2 is updated from the one shown in FIG. 18 to the one shown in FIG. 22.

As explained above, according to the fourth embodiment, the content distributing company or the like that has been authorized is able to update the authentication information stored in the storage device 100-4.

As explained above, according to the first through the fourth embodiments, the authentication information that permits writing data into the secret area and the authentication information that only permits reading data from the secret area are stored separately from each other, so that the authentication information to be used is changed according to whether the request is a write request or a read request. With this arrangement, only such devices that have stored therein the authentication information that permits the writing are able to perform the data writing process. Further, even if the authentication information that permits the reading is illegitimately obtained from a device that is prone to be attacked, the information stored in the secret area cannot be rewritten.

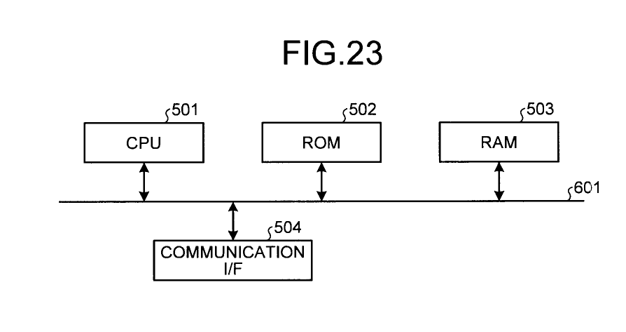

Next, a hardware configuration of the devices (i.e., the server and the content utilization terminal) according to the first through the fourth embodiments will be explained with reference to FIG. 23. FIG. 23 is a drawing explaining the hardware configuration of the devices according to any of the first through the fourth embodiments.

The devices according to any of the first through the fourth embodiments have a hardware configuration to which a commonly-used computer may be applied and are configured so as to include: a controlling device such as a Central Processing Unit (CPU) 501; storage media such as a Read Only Memory (ROM) 502 and a Random Access Memory (RAM) 503; a communication interface (I/F) 504 that establishes a connection to a network and performs communication; an external storage device such as a Hard Disk Drive (HDD) and/or a Compact Disk (CD) drive device; a display device such as a display monitor; an input device such as a keyboard and/or a mouse; and a bus 601 that connects these components to one another.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirits of the inventions.

What is claimed is:

1. A storage device comprising:
a data storage unit including a secret area that becomes readable in a case where authentication has been made by using reading authentication information and that becomes writable in a case where authentication has been made by using writing authentication information;
a receiving unit that receives an access request that is either a write request indicating that data should be written into the secret area or a read request indicating that data should be read from the secret area;
a selecting unit that selects the writing authentication information in a case where the access request is the write request and that selects the reading authentication information in a case where the access request is the read request; and
an authenticating unit that authenticates an access to the secret area by using one of the writing authentication information and the reading authentication information that has been selected.

2. The storage device according to claim 1, further comprising:
an authentication information storage unit that stores therein the writing authentication information and the reading authentication information; and
an updating unit that, in a case where an access to the authentication information storage unit has been authenticated, updates at least one of the writing authentication information and the reading authentication information that are stored in the authentication information storage unit, wherein
the receiving unit receives an update request indicating that at least one of the writing authentication information and the reading authentication information that are stored in the authentication information storage unit should be updated,
in a case where the update request has been received, the selecting unit selects the writing authentication information, and
in the case where the update request has been received, the authenticating unit authenticates the access to the authentication information storage unit by using the writing authentication information that has been selected.

3. The storage device according to claim 1, wherein
the data storage unit includes a plurality of secret areas that are associated with pieces of reading authentication information that are different from one another and pieces of writing authentication information that are different from one another,
the receiving unit receives the access request that includes identification information identifying at least one of the secret areas, and
the selecting unit selects one of the pieces of writing authentication information that corresponds to the secret area identified by the identification information in a case where the access request corresponding to the secret area identified by the identification information is the write request, whereas the selecting unit selects one of the pieces of reading authentication information that corresponds to the secret area identified by the identification information in a case where the access request corresponding to the secret area identified by the identification information is the read request.

4. An information processing apparatus including a storage device that stores data therein and an accessing device that accesses the data, wherein
the storage device comprises:
a data storage unit including a secret area that becomes readable in a case where authentication has been made by using reading authentication information and that becomes writable in a case where authentication has been made by using writing authentication information;
a receiving unit that receives an access request that is either a write request indicating that data should be written into the secret area or a read request indicating that data should be read from the secret area;
a selecting unit that selects the writing authentication information in a case where the access request is the write request and that selects the reading authentication information in a case where the access request is the read request; and
an authenticating unit that authenticates an access to the secret area by using one of the writing authentication information and the reading authentication information that has been selected, and
the accessing device comprises: a transmitting unit that transmits the read request to the storage device.
